(19) United States
(12) Patent Application Publication
(10) Pub. No.: US 2004/0221112 A1
(43) Pub. Date: Nov. 4, 2004

(54) Data storage and distribution apparatus and method

(76) Inventor: Zvi Greenfield, Kfar Saba (IL)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/425,394

(22) Filed: Apr. 29, 2003

(51) Int. Cl. G06F 12/00

(52) U.S. Cl. 711/148; 711/119

(57) ABSTRACT

A data storage and distribution apparatus provides parallel data transfer between a segmented memory and the apparatus outputs. The apparatus consists of a segmented memory and a switching grid-based interconnector. The segment memory is formed from a group of memory segments, which each have a data section and an associative memory section. A switching grid-based interconnector is connected to the segmented memory, and provides parallel switchable connections between each of the outputs to selected memory segments.

### FIELD AND BACKGROUND OF THE INVENTION

The present invention relates to data caching and distribution for a segmented memory and, more particularly, to segmented memory data caching and distribution in a parallel processing environment.

Digital signal processors (DSPs), and other data processing systems performing high-speed processing of real-time data, often use parallel processing to increase system throughput. In these systems, multiple processors and input/output (I/O) devices may be coupled to a shared memory. Processing is often pipelined in order to further increase processing speed. Parallel access to system memory and an effective caching scheme are required in order to service the requests from multiple processors in a timely manner.

One method for enabling parallel access to a memory is memory segmentation. With memory segmentation, the memory is subdivided into a number of segments which can be accessed independently. Parallel access to the memory segments is provided to each of the processing agents, such as processors and I/O devices, so that multiple memory accesses can be serviced in parallel. Each memory segment contains only a portion of the data. A processor accessing data or instructions stored in the memory must address the relevant memory segment.

Memory segmentation for parallel processing presents several challenges to system designers. Agents should be able to freely select any desired segment. Secondly, cache management is complex. Effective caching is particularly critical when larger memories, such as embedded dynamic random access memories (EDRAMs), are used. These larger memories have relatively long access times, and the access times may be non-uniform. Using a single cache for the entire memory is often ineffective. For effective operation the cache memory for a segmented memory should fulfill several requirements, which a single cache memory may not be able to meet adequately. The cache memory should be multi-port, with the number of ports equal to the number of parallel accesses required in a given bus clock cycle. Additionally, the cache memory should have an adequate capacity to effectively provide caching for the entire main memory, and yet be sufficiently fast to service the requests from all the connected agents. In order to solve these conflicting requirements, multiple cache memories may be used. Caching the main memory simultaneously into several cache memories creates new difficulties. With multiple cache memories cache coherency must be maintained to ensure that every processor always operates on the latest value of the data. Memory segmentation significantly complicates cache coherency issues.

Both multiple data buses and crossbar switches have been used to provide processing agents with parallel access to a segmented memory. Reference is now made to FIG. 1, which illustrates the multiple data bus solution. When multiple buses are used, each processing agent is connected to several data buses, which form parallel data paths to the memory segments. In the multiple bus system 100, a separate data bus (110.1 to 110.3) is dedicated to each memory segment (120 to 140). The agents (150 to 160) are coupled to each one of these data buses. In order to access a memory segment, the agent addresses the data bus connected to the desired memory segment.

Reference is now made to FIG. 2, which illustrates the crossbar switch solution for parallel connection of multiple agents to the memory segments. The crossbar 210 is a switching grid connecting system agents (processor, processing element, or I/O device), 220-230, to memory segments, 250.1-250.3. The crossbar switch 210 selectively interconnects each agent to a specified memory segment via a dedicated, point-to-point pathway. In order to access a memory segment, the agent specifies the requested memory segment to the crossbar switch. The crossbar then sets internal switches to connect the agent to the specified memory segment. The crossbar removes the problems associated with bus utilization, and can provide a higher data transfer rate.

Currently, memory caching for parallel processing is often performed by associating a local cache memory with each processor, as shown in FIG. 3. When each processor maintains its own cache, the problem of cache management is complex, regardless of how the agents and memory segments are connected. Multiple copies of the same data may be kept in the different processor cache memories. A cache coherency mechanism is required to ensure that a processor requesting a data item from main memory receives the most updated copy of the data, even if the most recent copy only resides in another processor's local cache.

Cache memories commonly use one of two methods to ensure that the data in the system memory is current, copyback and write-through. Both are problematic for the kind of parallel processing systems that have cache memories dedicated to the individual processing agents. The copyback method updates the main memory only when the data in the cache memory is replaced, and only if the data in the system memory does not equal the current value stored in the cache. The copyback method is problematic in multiple cache systems since the main memory does not necessarily end up containing the correct data values. When a processor replaces data in its own cache the replaced data may be written to the main memory, even though a more up to date value may be stored in a different processor's cache memory. If another processor requests the same data, the main memory may return an incorrect value. Also, if several processors have cached the same data value and one of the processors modifies the data, the cache memories of the remaining processors no longer contain an up to date value. If one of the remaining processors accesses the data from its own cache an incorrect value will be returned. Thus, in a multiple cache system where each processor manages its own cache, a mechanism is required to ensure that the data is current in all of the cache memories.

The write-through method, by contrast, updates the main memory whenever data is written to one of the cache memories. Thus the main memory always contains the most updated data values. The write-through method has the disadvantage, however, that it places a significant load on the data buses, since every data update requires additional writes to system memory and to any other processor caches that may be caching the relevant data.

When an unsegmented memory is used, cache activity can be monitored by snooping a central data bus. Memory segmentation complicates the cache coherency situation because different segments use different buses, and thus processors may no longer snoop a single bus to ensure that they have the most recent data within their local caches. Instead, another, more complex, coherency mechanism must be utilized. For example, caches may be required to send invalidation requests to all other caches following a modification to a cached data item. Invalidation requests alert the caches receiving these requests to the fact that the most recent copy of the data item resides in another local cache. Although this method maintains coherency, the overhead imposed by sending invalidation requests becomes prohibitive as the number of processors in the system increases.

U.S. Pat. No. 6,457,087 by Fu discloses a system and method for operating a cache-coherent shared-memory multiprocessing system. The system includes a number of devices including processors, a main memory, and I/O devices. The main memory contains one or more designated memory devices. Each device is connected by a dedicated point-to-point connection or channel to a flow control unit (FCU). The FCU controls the exchange of data between each device in the system by providing a communication path between two devices connected to the FCU. Each signal path can operate concurrently, thereby providing the system with the capability of processing multiple data transactions simultaneously. In Fu, the cache memories are associated with the processors. The FCU maintains cache coherency by including a snoop signal path to monitor the network of signal paths that are used to transfer data between devices. Processing resources must be devoted to both snooping the data paths, and to updating or invalidating cache memory data during memory operations.

Bauman in U.S. Pat. No. 6,480,927 presents a modular memory system with a crossbar. The system is a modular, expandable, multi-port main memory system that includes multiple point-to-point switch interconnections and a highly parallel data path structure allowing multiple memory operations to occur simultaneously. The main memory system includes an expandable number of modular Memory Storage Units (MSUs), each of which are mapped to a portion of the total address space of the main memory system, and may be accessed simultaneously. Each of the Memory Storage Units includes a predetermined number of modular memory banks, which may be accessed simultaneously through multiple memory ports. All of the memory devices in the system may perform different memory read or write operations substantially simultaneously and in parallel. Multiple data paths within each of the Memory Storage Units allow parallel data transfer operations to each of the MSU memory ports. The main memory system further incorporates independent storage devices and control logic to implement a directory-based coherency mechanism. A storage array within each of the MSU sub-units stores directory state information that indicates whether any cache line has been copied to, and/or updated within a cache memory coupled to the main memory system. This directory state information, which is updated during memory operations, is used to ensure memory operations are always performed on the most recent copy of the data. Bauman's device requires constant monitoring of memory activity. Since the crossbar is a multiple input/multiple output device, there is no centralized bus for data communication, and several data channels must be monitored simultaneously. Cache coherency therefore requires a significant investment of processing resources.

Current solutions for providing parallel access to a segmented memory require complex cache coherency schemes, which significantly increase processing overhead. There is thus a widely recognized need for, and it would be highly advantageous to have, a parallel-access segmented memory devoid of the above limitations.

### SUMMARY OF THE INVENTION

According to a first aspect of the present invention there is provided a data storage and distribution apparatus, for providing parallel data transfer. The data storage and distribution apparatus consists of a segmented memory and a switching grid-based interconnector. The segmented memory has a plurality of memory segments, where each of the memory segments contains a data section and an associative memory section connected to the data section. The switching grid-based interconnector provides in parallel switchable connections between multiple apparatus outputs and selectable memory segments.

Preferably, within a memory segment, the data section and the associative memory section are connected by a local data bus.

Preferably, the outputs are associated with respective processing agents.

Preferably, a memory segment further contains an internal cache manager for caching data between the memory segment's data section and associative memory section.

Preferably, the switching grid-based interconnector consists of a set of external data ports, each associated with a respective output, a set of memory data ports, each associated with a respective memory segment, and a switching grid, that switchably connects the external data ports to respective memory data ports, along parallel dedicated data paths according to memory data port selections made at each output.

Preferably, at least one memory segment contains an embedded dynamic random access memory (EDRAM).

Preferably, at least one memory segment contains a static random access memory (SRAM).

Preferably, for a given bus clock cycle, the interconnector is operable to connect the outputs to respective selectable memory segments.

Preferably, a memory segment is operable to input data from a connected agent.

Preferably, a memory segment is operable to output data to a connected agent.

Preferably, the interconnector contains a collision preventer for preventing simultaneous connection of more than one output to a memory segment.

Preferably, the collision preventer contains a prioritizer. The prioritizer sequentially connects outputs attempting simultaneous connection to a given memory segment, according to a priority scheme.

Preferably, the data storage and distribution apparatus further contains external data buses, that connect the outputs to the respective agents.

Preferably, the data storage and distribution apparatus further an external bus controller, for controlling the external data buses.

Preferably, the external bus controller provides external bus wait logic.

Preferably, the number of the memory segments is not less than the number of the agents.

According to a second aspect of the present invention there is provided a parallel data processing apparatus, which performs parallel processing of data from a segmented memory. The parallel data processing apparatus contains a segmented memory, several agents that process data and perform read and write operations to the segmented memory, and a switching grid-based interconnector. The segmented memory contains multiple memory segments, which each contain a data section and an associative memory section. The switching grid-based interconnector is connected to the segmented memory, and provides in parallel switchable connections between each of the agents to selected memory segments.

Preferably, within a memory segment, the data section and the associative memory section are connected by a local data bus.

Preferably, a memory segment further contains an internal cache manager for caching data between the respective data section and the respective associative memory section.

Preferably, the switching grid based interconnector contains a set of external data ports, associated with respective agents, a set of memory data ports, associated with respective memory segments, and a switching grid, operable to switchably connect the external data ports to respective selected memory data ports, along parallel dedicated data paths according to memory data port selections made at each output.

Preferably, at least one memory segment contains an embedded dynamic random access memory (EDRAM).

Preferably, at least one memory segment contains a static random access memory (SRAM).

Preferably, for a given bus clock cycle, the interconnector is operable to connect the agents to respective selectable memory segments.

Preferably, a memory segment is operable to input data from a connected agent.

Preferably, a memory segment is operable to output data to a connected agent.

Preferably, the interconnector contains a collision preventer for preventing simultaneous connection of more than one agent to a memory segment.

Preferably, the collision preventer contains a prioritizer, operable to sequentially connect outputs attempting simultaneous connection to a given memory segment, according to a priority scheme.

Preferably, the agents are connected to the interconnector by respective external data buses.

Preferably, the parallel data processing apparatus further contains an external bus controller, for controlling the external data buses.

Preferably, the external bus controller is operable to provide external bus wait logic.

Preferably, the number of the memory segments is not less than the number of the agents.

According to a third aspect of the present invention there is provided a method for storing data in a segmented memory and distributing the data in parallel to a plurality of outputs. The method is performed by first storing data in a plurality of memory segments, where the memory segments consists of a respective data section and a respective associative memory section. Second, for each memory segment, caching data from the respective data section in the respective associative memory section. Finally, the outputs are switchably connected to respective selected memory segments via an interconnection grid.

Preferably, the method contains the further step of outputting data from a memory segment to a selected output.

Preferably, the method contains the further step of inputting data to a memory segment from a selected input.

Preferably, the method contains the further step of identifying outputs attempting to simultaneously connect to a single memory segment, and controlling the identified outputs to connect to the memory segment sequentially.

Preferably, the controlling is carried out according to a predetermined priority scheme.

Preferably, the number of the memory segments is at least the number of the outputs.

According to a fourth aspect of the present invention there is provided a method for parallel distribution of data from a segmented memory to processing. The method consists of the following steps: storing data in a plurality of memory segments (where the memory segments each a respective data section and a respective associative memory section), for each memory segment, caching data from the respective data section in the respective associative memory section, switchably connecting a plurality of agents to respective selected memory segments via an interconnection grid, and processing data from the segmented memory by the agents.

Preferably, the method contains the further step of outputting data from at least one memory segment to a connected agent.

Preferably, the method contains the further step of inputting data to at least one memory segment from a connected agent.

Preferably, the method contains the further step of identifying agents attempting to simultaneously connect to a single memory segment, and controlling the identified outputs to connect to the memory segment sequentially.

Preferably, the controlling is carried out according to a predetermined priority scheme.

Preferably, the number of the memory segments is not less than the number of the agents.

According to a fifth aspect of the present invention there is provided a data storage and distribution apparatus, for providing parallel data transfer between a segmented data storage region and each of a plurality of terminals. Each of the terminals is independently able to update data stored in the data storage region. The segmented data storage region contains a plurality of memory segments, where each memory segment consists of a main data storage section and an associative memory section connected to the main data storage section. The apparatus further contains a switching grid-based interconnector associated with the segmented data storage region, that provides in parallel switchable connections between each of the terminals and selectable ones of the memory segments, and is connected to the segmented data storage region via respective associative memory sections. The apparatus thereby ensures that all of the plurality of terminals update a given memory segment via the same associative memory section.

According to a sixth aspect of the present invention there is provided a method for connecting between a segmented memory and a plurality of terminals, where each terminal is independently able to update data in the segmented memory, and where the connecting is carried out via caching to an associative memory of the memory segment. The method consists of the following steps: arranging caching of data for each memory segment in the associative memory of the memory segment, providing in parallel switchable connections between each of the terminals and selectable ones of the memory segments via a switching grid-based interconnector, where the switching grid-based interconnector is connected to the segmented memory via the respective associative memories.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the Drawings

FIG. 1 illustrates a first prior art solution for connecting multiple agents to a segmented memory over a multiple data bus.

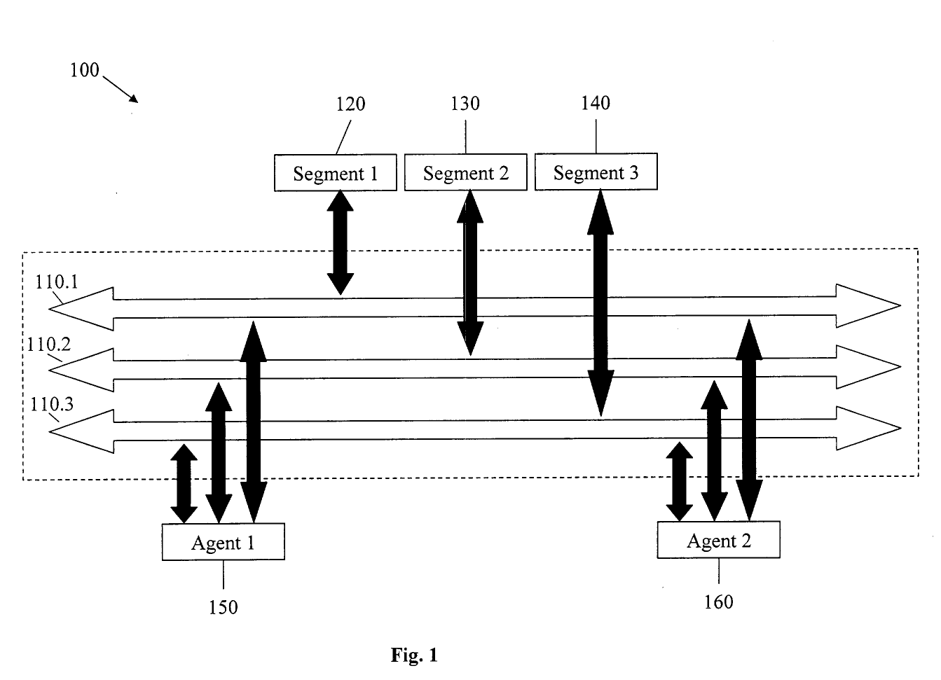

FIG. 2 illustrates a second prior art solution for connecting multiple agents to a segmented memory using a crossbar.

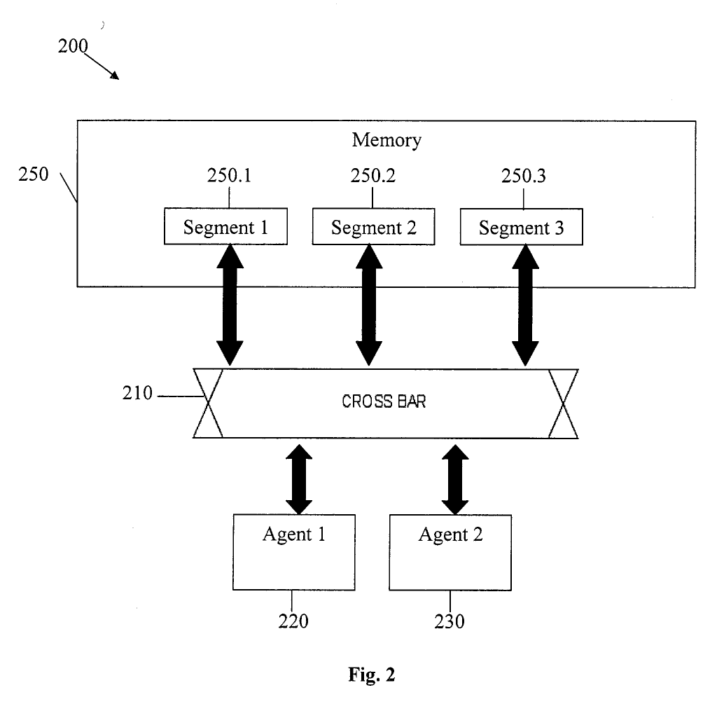

FIG. 3 shows a third prior art solution for memory caching for a parallel-access segmented memory using a dedicated cache memory for each processor.

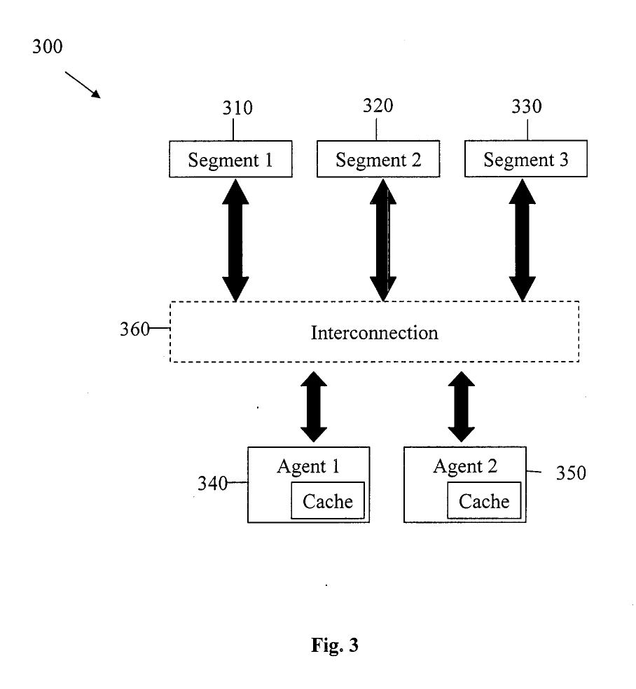

FIG. 4 is a simplified block diagram of a data storage and distribution apparatus, according to a first preferred embodiment of the present invention.

FIG. 5 is a simplified block diagram of a switching grid-based interconnector, according to the preferred embodiment.

FIG. 6 shows an example of a parallel data processing apparatus.

FIG. 7 is a simplified block diagram of a data storage and distribution apparatus, according to a second preferred embodiment of the present invention.

FIG. 8 is a simplified flowchart of a method for storing data in a segmented memory and of distributing the data in parallel to multiple outputs, according to a preferred embodiment of the present invention.

FIG. 9 is a simplified flowchart of a method for parallel distribution of data from a segmented memory to processing, according to a preferred embodiment of the present invention.

FIG. 10 is a simplified flowchart of a method for connecting between a segmented memory and a plurality of terminals, according to a preferred embodiment of the present invention.

### DESCRIPTION OF THE PREFERRED EMBODIMENTS

The present embodiments disclose a data storage and distribution apparatus and method, providing parallel, rather than bus, access to a segmented memory. Many applications, such as real-time signal processing, require parallel access to system memory and extremely fast read/write speeds. Memory segmentation provides a way of meeting these requirements. The larger system memory is subdivided into a number of smaller capacity segments, each of which can be accessed independently. Parallel access is provided, so that data requests from the processors and other connected devices are directed to the relevant memory segment. Memory speed is also increased due to the smaller size of the memory segments as compared to a single memory.

Specifically, the present embodiments reduce data distribution and cache coherency problems in a parallel processing system with a segmented memory. Parallel access is provided between independent processing agents which are each able to update memory data independently, and the various memory segments. Each agent is able to selectably connect to the required memory segment. In a system with multiple cache memories, and multiple processing agents, memory cache management is often complex. Care must be taken to ensure that the agents obtain the correct values at every memory access. The present embodiments simplify memory caching in a parallel processing environment by providing a separate cache for each memory segment.

The principles and operation of a data storage and distribution apparatus according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

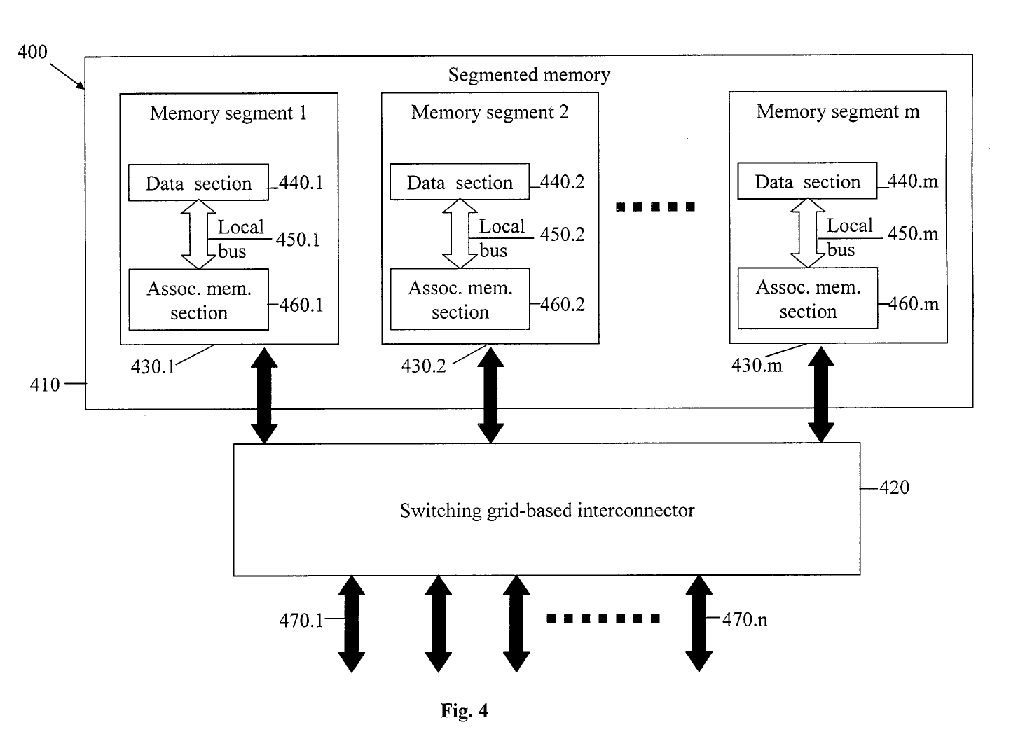

Reference is now made to FIG. 4, which is a simplified block diagram of a data storage and distribution apparatus, according to a first preferred embodiment of the present invention. The number of memory segments and outputs is for purposes of illustration only, and may comprise any number greater than one. Data storage and distribution apparatus 400 consists of a segmented memory 410 and a switching grid-based interconnector 420. The memory segments, 430.1-430.m, each have a data section 440 containing the stored data, and an associative memory section 460 serving as a local cache memory for the memory segment. The data section 440 and associative memory section 460 of each memory segment are connected together, preferably by a local data bus 450. The memory segments 430.1-430.m are connected in parallel to the switching grid based interconnector 420. In the preferred embodiment, the number of the memory segments (430.1-430.m) is equal to or greater than the number of interconnector outputs (470.1-470.n). Preferably, the interconnector outputs are connected to processing agents, such as processors, processing elements, and I/O devices.

Data storage and distribution apparatus 400 solves both the connectivity and cache coherency problems described above. Interconnector 420 is a switching grid, such as a crossbar, which provides parallel switchable connections between the interconnector inputs and the memory segments. When interconnector 420 receives a command to connect an input to a specified memory segment, internal switches within interconnector 420 are set to form a pathway between the input and the memory segment. No further addressing commands need be sent with the incoming data from the input port. In this way, parallel connections are easily provided from the memory segments to the interconnector outputs (which may be connected in turn to processing agents). These connections impose relatively little communication overhead on the connected agents. In the preferred embodiment, interconnector 420 connects each output to the specified memory segment for the given time interval.

Preferably, memory segments 430 input and/or output data to and from agents connected to interconnector 420. The data stored in the data section may include program instructions. In the preferred embodiment at least one of the memory segments 410 is an EDRAM. Alternately, one or more memory segments may be static random access memories (SRAMs).

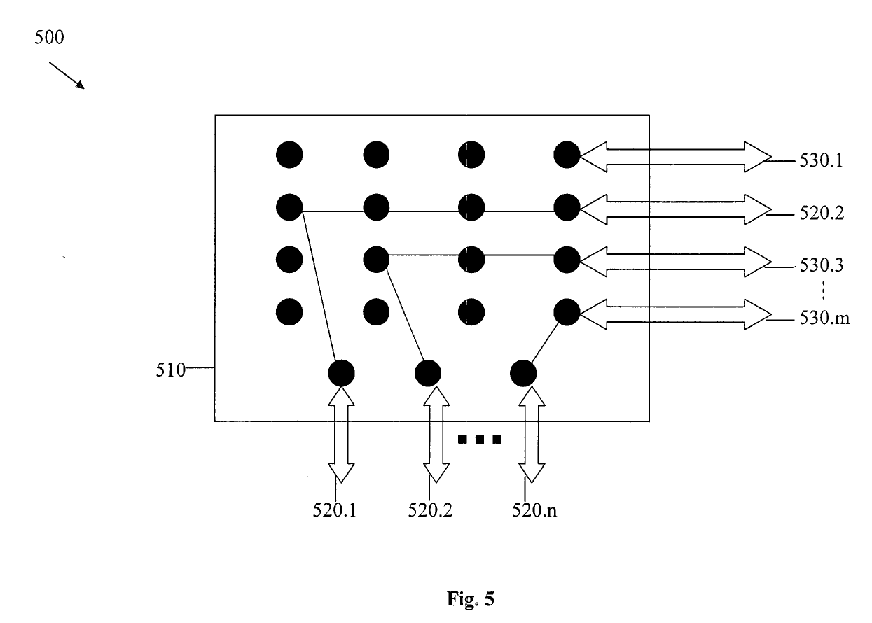

Reference is now made to FIG. 5, which is a simplified block diagram of a switching grid-based interconnector, according to the preferred embodiment. Interconnector 500 consists of a switching grid 510 connected to two sets of data ports, the external data ports 520, and the memory data ports 530. The number of external data ports 520 and memory data ports 530 is for illustration purposes only, and may be any number greater than one. The external data ports 520 serve as inputs to the data storage and distribution apparatus. Switching grid 510 connects each external data port to a selected memory data port. The memory data ports 530 connect in parallel to data buses, each data bus being dedicated to one of the memory segments. The interconnector 500 thus forms switchable, parallel data paths between the interconnector's external data ports 520 and the memory data ports 530, according to the memory port selection made at each output.

Referring again to FIG. 4, when agents connected to the data storage and distribution apparatus independently access the various memory segments, a collision can arise when more than one agent attempts to access a given memory segment during the same time interval. In order to prevent collision, interconnector 420 preferably contains a collision preventer. In the preferred embodiment, the collision preventer contains a prioritizer which prevents more than one agent from connecting to a single memory segment simultaneously, but instead connects agents wishing to connect to the same memory segment sequentially, according to a priority scheme. The priority scheme specifies which agents are given precedence to the memory segments under the current conditions.

In the preferred embodiment, interconnector 420 further contains external data buses, which connect between the agents and the respective external data ports. Interconnector 420 may also contain an external bus controller, for controlling the external data buses. The external bus controller may provide external bus wait logic, which assists in collision management, as described below.

Cache coherency is easily maintained in the preferred embodiment. Each memory segment 430 has a dedicated associative memory, which caches the data for a single memory segment. No cache coherency problems arise, since there are no multiple cached copies of the data. When an agent accesses a memory segment 430.x, only the associative memory of the accessed memory segment is checked to determine if it hold the required data. If the data is not cached in the segment's associative memory 460.x, then the data present in the segment's data section 440.x is up to date. The complex issue of monitoring the information contained in multiple cache memories with a parallel access configuration is eliminated. Each memory segment 430 preferably contains an internal cache manager that is responsible for caching information from the segment's data section in the associative memory. Any method used to update main memory for a single cache system may be employed, since each memory segment functions essentially as a single cache system.

In a further preferred embodiment the data storage and distribution apparatus additionally contains processing agents connected in parallel to the interconnector, and functions as a parallel data processing apparatus. The parallel data processing apparatus performs parallel processing of data from the segmented memory. The switching grid-based interconnector switchably connects the agents in parallel to selected memory segments. The agents process data, and perform read and write operations to the segmented memory.

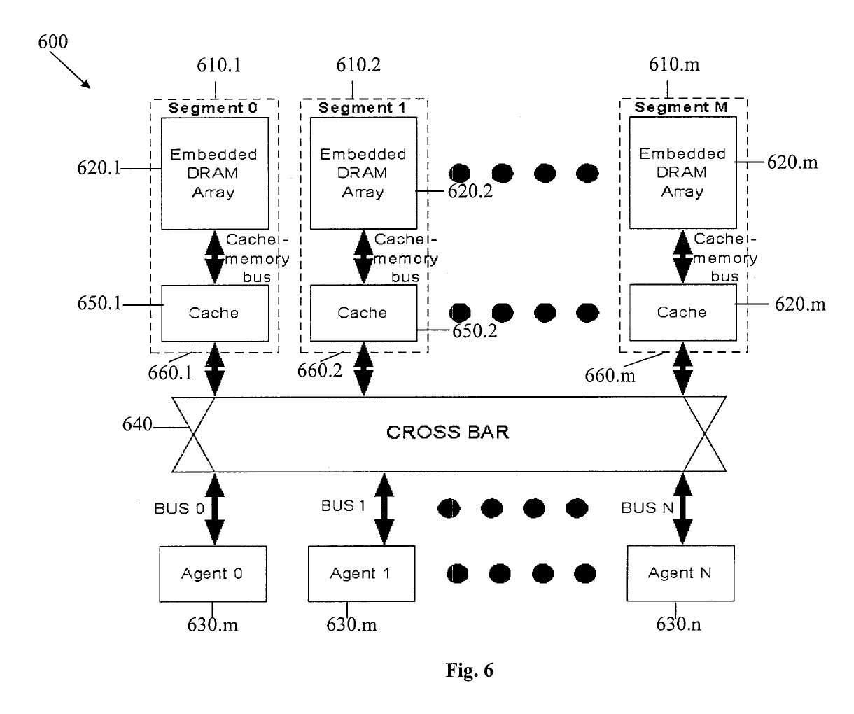

Reference is now made to FIG. 6, which shows an example of a parallel data processing apparatus 600 with memory segments 610.1..610.m having EDRAM data sections 620.1-620.m, and connected to the processing agents 630.1..630.n by a crossbar 640. Memory segments 610 each contain an individual cache memory 650 which is connected to the segment's EDRAM data section 620 by a cache memory bus 660. Parallel data processing apparatus 600 performs parallel processing of data stored in the memory segments and data input/output to the memory. Relatively few resources must be devoted by the agents in order to access data from the segmented memory. Cache management is performed internally to the memory segment.

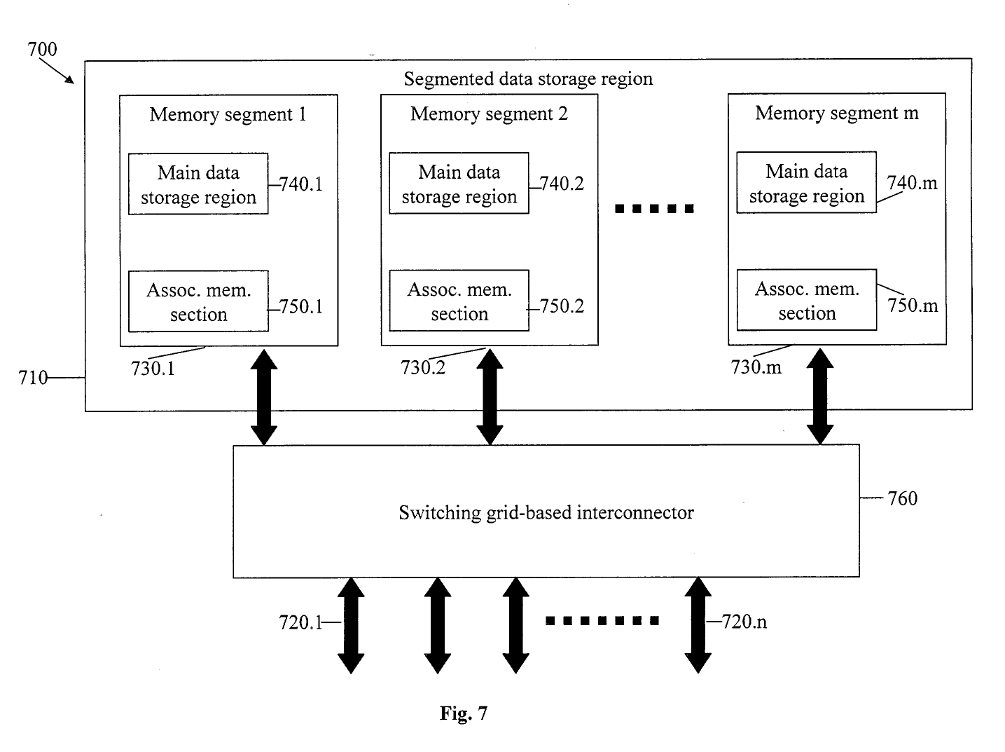

Reference is now made to FIG. 7, which is a simplified block diagram of a data storage and distribution apparatus, according to a second preferred embodiment of the present invention. Data storage and distribution apparatus 700 provides parallel data transfer between a segmented data storage region 710 and multiple terminals 720.1-720.n. The segmented data storage region 710 is composed of several memory segments 730.1-730.m. Each memory segment 730 has a main data storage region 740, and an associative memory section 750, which serves to cache the data from the segment's main data section 740.x. The terminals 720.1-720.n are connected to the segmented data storage region 710 by a switching grid-based interconnector 760, which provides switchable connections between each terminal and a selected memory segment. For each memory segment 730, the switching grid-based interconnector 760 connects to the segment's associative memory section 750, and through the associative memory section 750 to the segment's main data storage region 740. The terminals 720.1-720.n serve to transfer data between processing agents connected to the terminals 720.1-720.n and the segmented data storage region 710, such that each of the terminals 720.1-720.n is independently able select a memory segment 730, and to update data stored in the selected segment's main data storage region 740. The terminals 720.1-720.n are connected to the segmented data storage region 710 in parallel, so that for a given data bus cycle multiple terminals can be connected to respective selected memory segments. In the preferred embodiment a collision preventer prevents the simultaneous connection of several terminals to a single memory segment 730. Connecting the terminals to the memory segments 730.1-730.m through the segments' associative memory sections 750.1-750.m ensures that all of the terminals 720.1-720.n update a given memory segment via a single, dedicated associative memory section. Since the data for a given memory segment 720 is cached in a single associative memory section 750, to which all the terminals have access, no cache coherency problems arise. Any connected agent can locate the most up to date data, even in the case where cached data was modified by an agent connected to a different terminal, but has not yet been updated in the main data storage section.

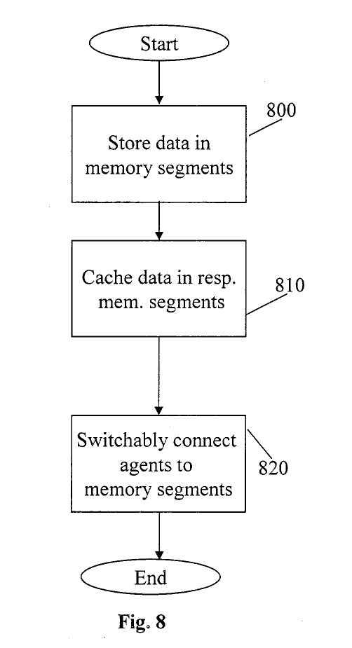

Reference is now made to FIG. 8, which is a simplified flowchart of a method for storing data in a segmented memory and of distributing the data in parallel to multiple outputs, according to a preferred embodiment of the present invention. In step 800, data is stored in a segmented memory, which consists of two or more memory segments. The memory segments each have a data section and an associative memory section. In step 810 data caching is performed, as necessary, within each memory segment. When data stored in a memory segment's data section is to be cached, the data is stored in the segment's associative memory section only. When a given memory segment is accessed, only the associative memory section of the selected memory segment is checked for the cached data, by comparing the main memory address of the required data with the main memory addresses of data stored in the associative memory. The current, up to date value is found either in the segment's associative memory or in the segment's data section. Finally, in step 820, the outputs, which serve as connection terminals for the processing agents, are connected to the memory segments in a switchable manner, via an interconnection grid. Connecting an output to a selected memory segment is accomplished by configuring a switching grid interconnector to form parallel, dedicated data paths between the outputs and the specified memory segments. Data access under the present embodiment is straightforward. The cache coherency mechanism generally required when memory data with multiple cache memories is not necessary. Since no snooping or other monitoring of the data connections is required for cache coherency reasons, the parallel paths are formed independently. Thus each agent is able to connect when it likes to any one of the memory segments. The agents are able to connect via a cache in the usual way, and the only overhead is that needed to ensure that two agents do not connect simultaneously to the same segment. Data is then exchanged in either direction along the parallel paths formed, and the data in the cache retains its integrity as described.

Preferably, the number of memory segments is at least the number of outputs or agents. Access to the segmented memory can then be provided to all outputs, as long as two outputs do not attempt to access the same memory segment simultaneously. Preferably, if multiple outputs (or agents) attempt to access a given memory segment, the outputs are connected to the memory segment in a sequential manner. In the preferred embodiment a priority scheme is used to determine the order in which the outputs are connected to the memory segment.

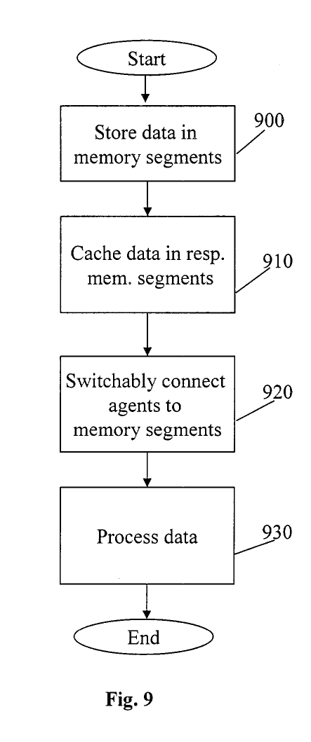

Reference is now made to FIG. 9, which is a simplified flowchart of a method for parallel distribution of data from a segmented memory to processing, according to a preferred embodiment of the present invention. The current method is similar to the method described above for FIG. 8, with the addition of a step of carrying out processing of the data. In step 900 data is stored in a segmented memory, which consists of two or more memory segments, each having a main data section and an associative memory section. In step 910 data caching is performed by transferring requested or expected-to-be-requested parts of the data from the data section to the associative memory section in each memory segment. The agents are connected to the memory segments in a switchable manner, via an interconnection grid in step 920, so that each agent receives the data it needs from whichever memory segment it happens to be stored in. Finally, in step 930, data from the segmented memory is processed by the agents.

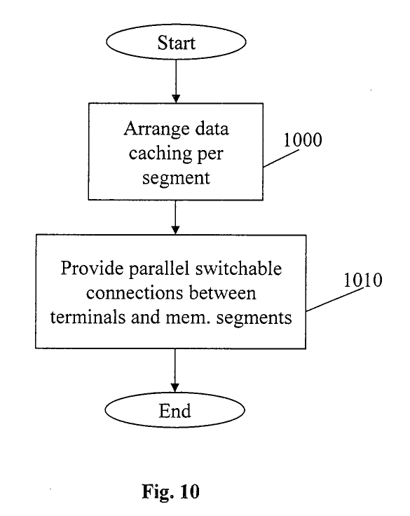

Reference is now made to FIG. 10, which is a simplified flowchart of a method for connecting between a segmented memory and a plurality of terminals, according to a preferred embodiment of the present invention. Each terminal is independently able to update data in the segmented memory. The terminals access and modify the data stored in each memory segment via the segment's dedicated associative memory, which serves as a faster cache memory for the memory segment. In step 1000 data caching is arranged for each memory segment, so that data from a given segment is cached in the segment's associative memory. In step 1010, parallel switchable connections are provided between each terminal to a selected memory segment. The connections are made via a switching grid-based interconnector, which connects the terminal to the selected memory segment's associative memory. Data for a given memory segment is cached only in the memory segment's associative memory. Access to data stored in a given segment is provided only via the segment's own data cache. A processing agent connected to a terminal is thereby always able to access up to date data, even if the data has not yet been updated within the memory segment.

Processing speed is a crucial element of many systems, and particularly for real-time parallel data processors. Reducing processing overhead and memory access speeds can significantly improve the performance of such systems. The above-described embodiments address both of these issues. Memory segmentation, with a dedicated cache memory for each memory segment, provides parallel access to stored information with relatively simple cache management protocols. The parallel connections between the memory segments and the processing and/or I/O devices are defined by simple commands sent from the agent to the connector, and require no further communication addressing. Processing capabilities, as well as design effort, can be devoted to other tasks. Thus copy back caching is possible without excessive overhead in a parallel processing environment. Furthermore, write through caching is convenient to implement using the present embodiments.

It is expected that during the life of this patent many relevant data storage and transfer devices will be developed and the scopes of the respective terms “memory”, “cache”, “agent”, “terminal”, and “crossbar” are intended to include all such new technologies a priori.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A data storage and distribution apparatus, for providing parallel data transfer, said apparatus comprising:
a segmented memory comprising a plurality of memory segments, each of said memory segments comprising a respective data section and a respective associative memory section connected to said data section; and
a switching grid-based interconnector associated with said segmented memory, for providing in parallel switchable connections between each of a plurality of outputs to selectable ones of said memory segments.

2. A data storage and distribution apparatus according to claim 1, wherein, within a memory segment, said data section and said associative memory section are connected by a local data bus.

3. A data storage and distribution apparatus according to claim 1, wherein said outputs are associated with respective processing agents.

4. A data storage and distribution apparatus according to claim 1, wherein a memory segment further comprises an internal cache manager for caching data between said respective data section and said respective associative memory section.

5. A data storage and distribution apparatus according to claim 1, wherein said switching grid-based interconnector comprises:
a set of external data ports, associated with respective outputs;
a set of memory data ports, associated with respective memory segments; and
a switching grid, operable to switchably connect said external data ports to respective memory data ports, along parallel dedicated data paths according to memory data port selections made at each output.

6. A data storage and distribution apparatus according to claim 1, wherein at least one memory segment comprises an embedded dynamic random access memory (EDRAM).

7. A data storage and distribution apparatus according to claim 1, wherein at least one memory segment comprises a static random access memory (SRAM).

8. A data storage and distribution apparatus according to claim 1, wherein, for a given bus clock cycle, said interconnector is operable to connect said outputs to respective selectable memory segments.

9. A data storage and distribution apparatus according to claim 3, wherein a memory segment is operable to input data from a connected agent.

10. A data storage and distribution apparatus according to claim 3, wherein a memory segment is operable to output data to a connected agent.

11. A data storage and distribution apparatus according to claim 1, wherein said interconnector comprises a collision preventer for preventing simultaneous connection of more than one output to a memory segment.

12. A data storage and distribution apparatus according to claim 11, wherein said collision preventer comprises a prioritizer, operable to sequentially connect outputs attempting simultaneous connection to a given memory segment, according to a priority scheme.

13. A data storage and distribution apparatus according to claim 3 further comprising external data buses, for connecting said outputs to said respective agents.

14. A data storage and distribution apparatus according to claim 13, further comprising an external bus controller, for controlling said external data buses.

15. A data storage and distribution apparatus according to claim 14, wherein said external bus controller is operable to provide external bus wait logic.

16. A data storage and distribution apparatus according to claim 3, wherein the number of said memory segments is not less than the number of said agents.

17. A parallel data processing apparatus, for parallel processing of data from a segmented memory, said apparatus comprising:
a segmented memory comprising a plurality of memory segments, said memory segments comprising a respective data section and a respective associative memory section;
a plurality of agents for processing data, and for performing read and write operations to said segmented memory; and
a switching grid-based interconnector associated with said segmented memory, for providing in parallel switchable connections between each of said agents to selectable ones of said memory segments.

18. A parallel data processing apparatus according to claim 17, wherein, within a memory segment, said data section and said associative memory section are connected by a local data bus.

19. A parallel data processing apparatus according to claim 17, wherein a memory segment further comprises an internal cache manager for caching data between said respective data section and said respective associative memory section.

20. A parallel data processing apparatus according to claim 17, wherein said switching grid based interconnector comprises:
a set of external data ports, associated with respective agents;
a set of memory data ports, associated with respective memory segments; and
a switching grid, operable to switchably connect said external data ports to respective selected memory data ports, along parallel dedicated data paths according to memory data port selections made at each output.

21. A parallel data processing apparatus according to claim 17, wherein at least one memory segment comprises an embedded dynamic random access memory (EDRAM).

22. A parallel data processing apparatus according to claim 17, wherein at least one memory segment comprises a static random access memory (SRAM).

23. A parallel data processing apparatus according to claim 17, wherein, for a given bus clock cycle, said interconnector is operable to connect said agents to respective selectable memory segments.

24. A parallel data processing apparatus according to claim 17, wherein a memory segment is operable to input data from a connected agent.

25. A parallel data processing apparatus according to claim 17, wherein a memory segment is operable to output data to a connected agent.

26. A parallel data processing apparatus according to claim 17, wherein said interconnector comprises a collision preventer for preventing simultaneous connection of more than one agent to a memory segment.

27. A parallel data processing apparatus according to claim 26, wherein said collision preventer comprises a prioritizer, operable to sequentially connect outputs attempting simultaneous connection to a given memory segment, according to a priority scheme.

28. A parallel data processing apparatus according to claim 17, wherein said agents are connected to said interconnector by respective external data buses.

29. A parallel data processing apparatus according to claim 28, further comprising an external bus controller, for controlling said external data buses.

30. A parallel data processing apparatus according to claim 29, wherein said external bus controller is operable to provide external bus wait logic.

31. A parallel data processing apparatus according to claim 17, wherein the number of said memory segments is not less than the number of said agents.

32. A method for storing data in a segmented memory and distributing said data in parallel to a plurality of outputs, comprising:
storing data in a plurality of memory segments, said memory segments comprising a respective data section and a respective associative memory section;
for each memory segment, caching data from said respective data section in said respective associative memory section; and
switchably connecting said outputs to respective selected memory segments via an interconnection grid.

33. A method for storing data in a segmented memory and distributing said data in parallel to a plurality of outputs according to claim 32, further comprising outputting data from a memory segment to a selected output.

34. A method for storing data in a segmented memory and distributing said data in parallel to a plurality of outputs according to claim 32, further comprising inputting data to a memory segment from a selected input.

35. A method for storing data in a segmented memory and distributing said data in parallel to a plurality of outputs according to claim 32, further comprising identifying outputs attempting to simultaneously connect to a single memory segment, and controlling said identified outputs to connect to said memory segment sequentially.

36. A method for storing data in a segmented memory and distributing said data in parallel to a plurality of outputs according to claim 35, wherein said controlling is carried out according to a predetermined priority scheme.

37. A method for storing data in a segmented memory and distributing said data in parallel to a plurality of outputs according to claim 32, wherein the number of said memory segments is at least the number of said outputs.

38. A method for parallel distribution of data from a segmented memory to processing, comprising:
storing data in a plurality of memory segments, said memory segments comprising a respective data section and a respective associative memory section;
for each memory segment, caching data from said respective data section in said respective associative memory section;
switchably connecting a plurality of agents to respective selected memory segments via an interconnection grid; and
processing data from said segmented memory by said agents.

39. A method for parallel processing of data from a segmented memory according to claim 38, further comprising outputting data from at least one memory segment to a connected agent.

40. A method for parallel processing of data from a segmented memory according to claim 38, further comprising inputting data to at least one memory segment from a connected agent.

41. A method for parallel processing of data from a segmented memory according to claim 38, further comprising identifying agents attempting to simultaneously connect to a single memory segment, and controlling said identified outputs to connect to said memory segment sequentially.

42. A method for parallel processing of data from a segmented memory according to claim 41, wherein said controlling is carried out according to a predetermined priority scheme.

43. A method for parallel processing of data from a segmented memory according to claim 38, wherein the number of said memory segments is not less than the number of said agents.

44. A data storage and distribution apparatus, for providing parallel data transfer between a segmented data storage region and each of a plurality of terminals, each of said terminals being independently able to update data stored in said data storage region, wherein said segmented data storage region comprises a plurality of memory segments, each memory segment comprising a main data storage section and an associative memory section connected to said main data storage section, the apparatus further comprising a switching grid-based interconnector associated with said segmented data storage region, for providing in parallel switchable connections between each of said terminals and selectable ones of said memory segments, and wherein said switching grid-based interconnector is connected to said segmented data storage region via respective associative memory sections, thereby to ensure that all of said plurality of terminals update a given memory segment via the same associative memory section.

45. A method for connecting between a segmented memory and a plurality of terminals, each terminal being independently able to update data in said segmented memory, and wherein said connecting is carried out via caching to an associative memory of said memory segment, comprising:
arranging caching of data for each memory segment in said associative memory of said memory segment;
providing in parallel switchable connections between each of said terminals and selectable ones of said memory segments via a switching grid-based interconnector, wherein said switching grid-based interconnector is connected to said segmented memory via said respective associative memories.
